(19) United States
(12) Patent Application Publication
(10) Pub. No.: US 2025/0045901 A1
(43) Pub. Date: Feb. 6, 2025

(54) METHOD FOR IMPACT ANALYSIS OF PORT CONSTRUCTION ON COASTAL ECOTONE BASED ON REMOTE SENSING DATA

(71) Applicant: DALIAN UNIVERSITY OF TECHNOLOGY, Dalian (CN)

(72) Inventors: Wenyuan WANG, Dalian (CN); Yun PENG, Dalian (CN); Xinglu XU, Dalian (CN); Zijian GUO, Dalian (CN)

(21) Appl. No.: 18/923,138

(22) Filed: Oct. 22, 2024

(30) Foreign Application Priority Data
Dec. 19, 2023 (CN) 202311745322.4

(51) Int. Cl. G06T 7/00

(52) U.S. Cl. CPC G06T 7/0004

(57) ABSTRACT

The present invention provides a method for impact analysis of port construction on a coastal ecotone based on remote sensing data, which belongs to the technical field of remote sensing application. The method quantifies landscape data and satellite image data, and then converts the data into intuitive images to observe the spatio-temporal change of the coastal ecotone after port construction. The method includes: step 1: obtaining remote sensing image data of a research region; step 2: preprocessing the remote sensing image data to obtain processed images; step 3: establishing an evaluation system of human disturbance indexes; and step 4: generating a spatio-temporal distribution map of regional disturbance indexes. The present invention provides a method capable of quantifying the impact range and the impact degree of the port construction factor on the coastal ecotone, provides an idea for reducing the impact of port construction on a surrounding environment.

### TECHNICAL FIELD

The present invention relates to a method for analysis of port construction on a coastal ecotone based on remote sensing data, which belongs to the technical field of remote sensing application.

### BACKGROUND

The coastal ecotone includes woodland, bushes, farmland, homes, rivers, streams, natural lakes, swamps, temporary waters, artificial lakes, lawns, mangroves, coastal clearings and shorelines, which are habitat and breeding places for many organisms and play an important role in resisting floodwater, regulating runoff, storing floodwater for use in a drought, reducing pollution, regulating climate, controlling soil erosion, promoting sedimentation and producing land, and beautifying environment for coastal cities.

Due to the rapid development of coastal port construction in China in recent years, the adjacent ecological coastal ecotone has been greatly affected. Current monitoring methods are often scattered and lack overall and integrated monitoring solutions. Moreover, the existing monitoring often lacks sufficient frequency and effectiveness, and cannot capture these changes, leading to failure to comprehensively understand the dynamic changes in the region. An analysis and evaluation method for the impact of port construction on the ecological environment is established herein by means of remote sensing monitoring based on multi-temporal satellite images. The method is conducive to coordinating the relationship between port construction and ecological protection, making reasonable use of marine shoreline resources and alleviating environmental problems generated during port construction.

### SUMMARY

In view of the problems existing in the prior art, the present invention provides a method for monitoring the impact of port construction on a coastal ecotone, which can be used for assessing the change of the impact intensity of port construction on the coastal ecotone, analyzing the spatial change of the disturbance intensity of a surrounding environment at different time nodes of port construction, and finding out the spatio-temporal change rule and impact range of the impact of the port construction factor on the surrounding environment.

To achieve the above purpose, the present invention adopts the following technical solution:

A method for impact analysis of port construction on a coastal ecotone based on remote sensing data is provided. The method quantifies landscape data and satellite image data based on RS, human disturbance indexes, fishing net method and Kriging interpolation method, and converts the data into intuitive images to observe the spatio-temporal change of the coastal ecotone after port construction.

Specific steps are as follows:
Step 1: collecting satellite image data of a research region

A remote sensing monitoring technology can be used for monitoring and surveying a landscape. The first step is to collect required satellite image data, process the satellite image data, and extract land use types in various regions.

Wherein data collection can request the satellite image data of the coastal ecotone in a required region from an existing agency.
Step 2: preprocessing the remote sensing image data to obtain processed images

Data preprocessing means preprocessing of satellite images by ENVI software before subsequent processing, comprising, but not limited to, any one or more of the following processing: radiometric calibration, atmospheric correction, image fusion, image de-cloud, image mosaic, image cropping and classification of land use types. All kinds of processing are illustrated below.
(2.1) Radiometric calibration: eliminating uncertainty caused by sensor characteristics, atmospheric disturbance and other factors in the remote sensing data for accurate data analysis and interpretation; converting original remote sensing data into standardized radiation luminance value or radiation flux value through radiometric calibration.
(2.2) Atmospheric correction: for a purpose of eliminating errors caused by atmospheric scattering, absorption, reflection, etc.
(2.3) Image fusion: fusing remote sensing image data from different sensors or different bands to obtain more comprehensive and accurate information. The purpose is to improve the spatial and spectral resolution of the remote sensing data and enhance image quality.
(2.4) Image de-cloud: a small number of satellite images of cloud possibly cause certain disturbance to classification results, and de-cloud processing can be completed using a Haza module developed based on ENVI.
(2.5) Image mosaic and cropping: generally, it is difficult to completely cover a region by a single remote sensing image, so a plurality of satellite images need to be spliced by mosaic, or cropped according to the scope of the research region to select a region of interest.
(2.6) Classification of land use types: selecting a training set of each land use type manually, and obtaining the land use types in the research region by a method of supervised classification.
Step 3: establishing an evaluation system of human disturbance indexes
setting human disturbance indexes (HTL) according to the conversion of the land use types before, during and after port construction to characterize the impact intensity of port construction on a surrounding environment. The change of the land use types can provide important information about the impact of human activities on a landscape. Therefore, the analysis of the conversion
process of the land use types can reflect the spatial-temporal change of port construction disturbance. Disturbance types are divided into four categories that represent four different disturbance levels, which are almost no disturbance, weak disturbance, moderate disturbance and strong disturbance. The higher the human disturbance indexes are, the greater the disturbance intensity of port construction on the region is. A calculation method of the human disturbance indexes is shown in the following formula.

$$H T L = {\sum }_{i = 1}^{h} {f}_{n} * h$$

where fₙ represents the area occupied by different types of landscapes, and h represents the disturbance level corresponding to different landscapes. Table 1 Classification of Disturbance Levels

| Disturbance | | Disturbance |
|---|---|---|
| Type | Landscape Type | Level |
| Almost no | Suaeda heteroptera | 1 |
| disturbance | Kitagawa (F1) | |
| | Phragmites australis (F2) | 1 |
| | Bare soil (F3) | 1 |
| Weak | Tidal flat (F4) | 2 |
| disturbance | | |
| Moderate | Farmland (F5) | 3 |
| disturbance | | |
| Strong | Building (F6) | 4 |
| disturbance | Culture pond and reservoir | 4 |
| | (F7) | |

Step 4: generating a spatio-temporal distribution map of regional disturbance indexes using ArcGIS software. Specific steps are as follows:
(4.1) Raster to polygon: converting classified images into raster data, and converting surface elements into a raster data set to perform spatial analysis and area calculation more conveniently.
(4.2) Fishing net method: ArcGIS fishing net method can decompose the whole satellite image into multiple grids with the same size.
(4.3) Calculating disturbance indexes of fishing net grids: calculating the area of each landscape inside fishing net grids, and calculating the disturbance indexes; and assigning the disturbance indexes to the centers of the fishing net grids.
(4.4) Kriging interpolation method: converting the information of the disturbance index points of the fishing net grids into a planar distribution map of the disturbance indexes by an interpolation calculation formula according to the disturbance index value of the center of each fishing net grid.
(4.5) Raster to polygon: converting the disturbance index values in the fishing net raster into visual images.

The present invention has the following beneficial effects:

The present invention provides a method capable of quantifying the impact range and the impact degree of the port construction factor on the coastal ecotone, provides an idea for reducing the impact of port construction on the surrounding environment, and provides scientific reference for the ecological protection of the coastal ecotone.

### DESCRIPTION OF DRAWINGS

FIG. 1 is a flow chart of a method of the present invention;

FIG. 2 shows images after classification of land use types;

FIG. 3 shows spatio-temporal distribution maps of disturbance indexes.

### DETAILED DESCRIPTION

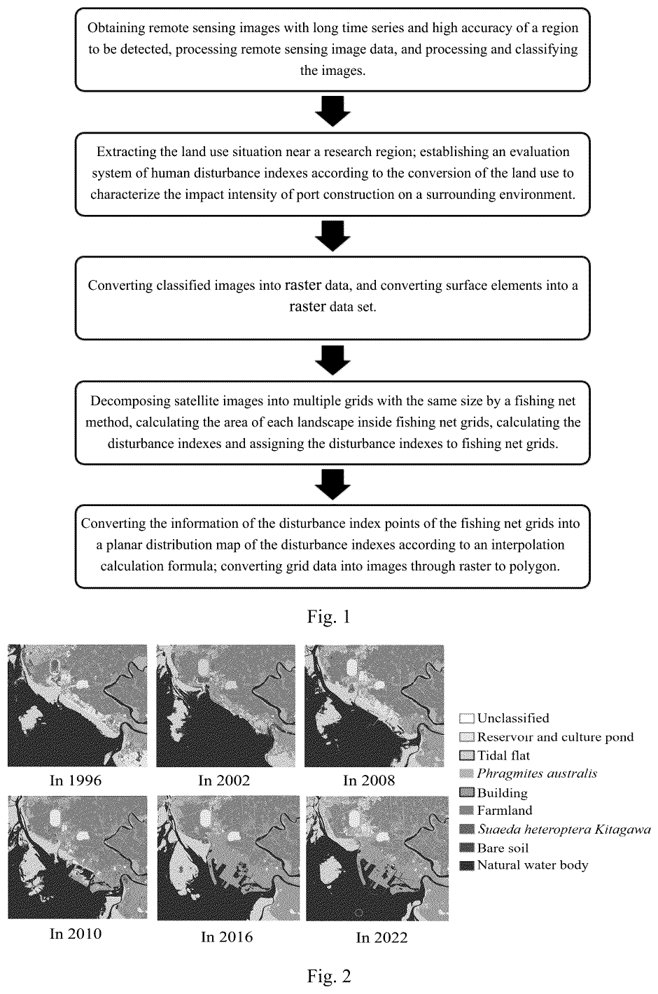

To make the purpose, the technical solution and the advantages of the present invention more clear, the present invention will be further described below in detail in combination with the specific embodiments and with reference to the accompanying drawings.
Embodiment 1: a method for monitoring the impact of port construction on a coastal ecotone based on remote sensing data (as shown in FIG. 1) comprises the following steps:
Step 1: obtaining remote sensing images with long time series and high accuracy of a required region, taking port construction as a key node, and selecting LandsatTM/ETM remote sensing images in 1996 and 2002 before the port construction, in 2008 and 2010 during the construction, and in 2016 and 2022 after the construction as the data basis for the research.
Step 2: preprocessing the remote sensing image data, collecting satellite image data of the research region, and processing the land use types of the images. The preprocessing includes radiometric calibration, atmospheric correction, research region cropping, and classification of land use types for the remote sensing data. The obtained results are shown in FIG. 2. It can be seen from FIG. 2 that the spatial distribution information of land cover types in different regions will be conducive to subsequent analysis of the impact degree and the impact range on the landscape of the coastal ecotone at different time nodes before, during and after port construction.
Step 3: establishing an evaluation system of human disturbance indexes; and according to the landscape type in the research region, dividing the landscape into Suaeda heteroptera Kitagawa,
Phragmites australis, bare soil, tidal flat, farmland, building, culture pond and reservoir. The landscapes and disturbance levels included in different disturbance types are shown in Table 1.
Step 4: generating a spatio-temporal distribution map of regional disturbance indexes using ArcGIS software.

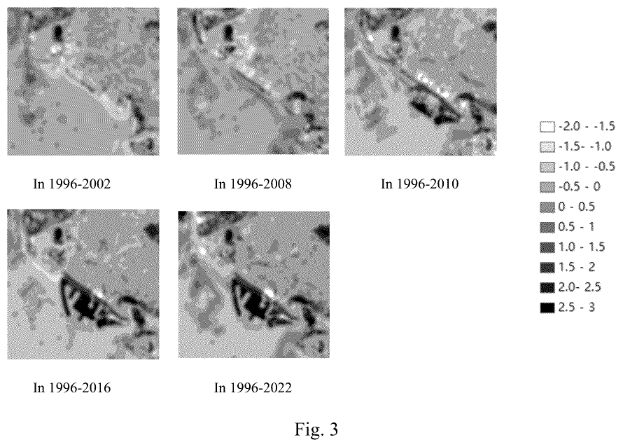

The land use situation near the research region is extracted. Human disturbance indexes are set according to the conversion of the land use to characterize the impact intensity of port construction on the surrounding environment. By using a fishing net creation tool in ArcGIS10.7, through raster to polygon, satellite images are divided into a total of 837 grids as evaluation units. Each unit is calculated as the disturbance index of the middle point of the unit. The Kriging interpolation method is used to form the planar distribution map of the disturbance indexes. Through raster to polygon, the final results are formed, as shown in FIG. 3. It can be seen from FIG. 3 that the overall impacted range is mainly within 3.5 km along the coastline. Before port construction, human disturbance is mainly in the west urban area of Yingkou City, east of Liaohe River, which is changed into Phragmites australis and replaced by farmland and buildings. During port construction, the changes focus on the culture pond and Suaeda heteroptera Kitagawa around the Bohai coastline and convert into buildings, and the residential areas inside the coastline are expanded. After the completion of the construction, the supporting buildings and transportation facilities near Panjin Port are continuously improved, and Suaeda heteroptera Kitagawa and Phragmites australis in the nature reserve are recovered, but the area of Phragmites australis along the Liaohe River is continuously decreased. Thus, the establishment of ecological preservation areas, the protection of the existing natural plants and the gradual return of reclaimed farmland to forest can play an important role in maintaining the ecological environment.

The above embodiments only express the implementation of the present invention, and shall not be interpreted as a limitation to the scope of the patent for the present invention. It should be noted that, for those skilled in the art, several variations and improvements can also be made without departing from the concept of the present invention, all of which belong to the protection scope of the present invention.

1. A method for impact analysis of port construction on a coastal ecotone based on remote sensing data, wherein the method quantifies landscape data and satellite image data, and then converts the data into intuitive images to observe the spatio-temporal change of the coastal ecotone after port construction, comprising:
step 1: obtaining remote sensing image data of a research region;
step 2: preprocessing the remote sensing image data to obtain processed images;
step 3: establishing an evaluation system of human disturbance indexes;
step 4: generating a spatio-temporal distribution map of regional disturbance indexes.

2. The method for impact analysis of port construction on the coastal ecotone based on remote sensing data according to claim 1, wherein specific steps are as follows:
step 1: collecting satellite image data of the research region to obtain the remote sensing image data of the research region;
step 2: preprocessing the remote sensing image data to obtain processed images;
wherein the preprocessing comprises, but not limited to, radiometric calibration, atmospheric correction, image fusion, image de-cloud, image mosaic, image cropping, and classification of land use types;
step 3: establishing an evaluation system of human disturbance indexes;
setting human disturbance indexes (HTL) according to the conversion of the land use types before, during and after port construction to characterize the impact intensity of port construction on a surrounding environment, wherein the analysis of the conversion process of the land use types can reflect the spatial-temporal change of port construction disturbance; disturbance types are divided into four categories that represent four different disturbance levels, which are almost no disturbance, weak disturbance, moderate disturbance and strong disturbance; the higher the human disturbance indexes are, the greater the disturbance intensity of port construction on the region is;
a calculation method of the human disturbance indexes is: HTL=Σᵢ₌₁^{h}fₙ×h, where fₙ represents the area occupied by different types of landscapes, and h represents the disturbance level corresponding to different landscapes;
TABLE 1
Classification of Disturbance Levels

| Disturbance | | Disturbance |
|---|---|---|
| Type | Landscape Type | Level |
| Almost no | Suaeda heteroptera Kitagawa | 1 |
| disturbance | (F1) | |
| | Phragmites australis (F2) | 1 |
| | Bare soil (F3) | 1 |
| Weak disturbance | Tidal flat (F4) | 2 |
| Moderate | Farmland (F5) | 3 |
| disturbance | | |
| Strong | Building (F6) | 4 |
| disturbance | Culture pond and reservoir | 4 |
| | (F7) | |

step 4: generating a spatio-temporal distribution map of regional disturbance indexes, with specific steps as follows:
(4.1) raster to polygon: converting classified images into raster data, and converting surface elements into a raster data set to perform spatial analysis and area calculation more conveniently;
(4.2) fishing net method: decomposing the whole satellite image into multiple grids with the same size by ArcGIS fishing net method;
(4.3) calculating disturbance indexes of fishing net grids: calculating the area of each landscape inside fishing net grids, and calculating the disturbance indexes; and assigning the disturbance indexes to the centers of the fishing net grids;
(4.4) Kriging interpolation method: converting the information of the disturbance index points of the fishing net grids into a planar distribution map of the disturbance indexes by an interpolation calculation formula according to the disturbance index value of the center of each fishing net grid;
(4.5) polygon to raster: converting the disturbance index values in the fishing net grids into visual images.

3. The method for impact analysis of port construction on the coastal ecotone based on remote sensing data according to claim 2, wherein in the step 2, the preprocessing mode is specifically as follows:
(2.1) radiometric calibration: eliminating uncertainty caused by sensor characteristics, atmospheric disturbance or other factors in the remote sensing data for accurate data analysis and interpretation; converting original remote sensing data into standardized radiation luminance value or radiation flux value through radiometric calibration;
(2.2) atmospheric correction: eliminating errors caused by atmospheric scattering, absorption, reflection, etc.;
(2.3) image fusion: fusing remote sensing image data from different sensors or different bands to obtain more comprehensive and accurate information, for the purpose of improving the spatial and spectral resolution of the remote sensing data and enhancing image quality;
(2.4) image de-cloud: completing de-cloud processing using a Haza module developed based on ENVI;
(2.5) image mosaic and cropping: splicing a plurality of satellite images by mosaic, or cropping the satellite images according to the scope of the research region to select a region of interest;
(2.6) classification of land use types: selecting a training set of each land use type, and obtaining the land use types in the research region by a method of supervised classification.
